(19) United States
(12) Patent Application Publication
(10) Pub. No.: US 2010/0220351 A1
(43) Pub. Date: Sep. 2, 2010

(54) SYSTEMS AND METHODS FOR PRINTER STATUS DETERMINATION

(75) Inventor: Surendra MAKAM, Boulder, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc..

(21) Appl. No.: 12/395,553

(22) Filed: Feb. 27, 2009

(51) Int. Cl. G06F 15/00

(52) U.S. Cl. 358/1.15

(57) ABSTRACT

Methods disclosed facilitate the obtaining and display of status information for printers. In some embodiments, a status request may be sent to a printer requesting the status of parameters whose status is tracked by the printer. In some embodiments, the MIB objects pertaining to parameters specified in the request may be represented using XML and a response to the status request may be sent, wherein the response includes an XML representation of the MIB objects. The requested status information may be displayed by parsing the response to the status request. The methods may be performed in whole, or in part, by one or more of a printer, a computer, and/or a handheld device that may be coupled through Bluetooth or USB connections.

### BACKGROUND

1. Field of the Invention

The present invention relates to the field of printing and in particular, to systems and methods for obtaining status information from printing devices.

2. Description of Related Art

Computer printers, which are ubiquitous in most modern organizations, permit the quick printing of stored documents. Typically, printers use ink, toner, etc. to place marks on print media. Therefore, printers include a number of moving parts and also use consumables. Accordingly, a number of situations arise during the operation of a printer when the printer may temporarily stall. For example, the printer may encounter a paper jam, or may run out of ink, toner, or print media. Such situations typically require human intervention. For example, in the situations described above the paper jam may be cleared, or the ink or toner may be replenished.

In organizations, which have a large number of printers that are physically distributed, the maintenance and upkeep of printers may be a time consuming and cumbersome task. Typically, the task may involve monitoring the printers, querying their status, and then dispatching service technicians to attend to service requests. The service technician may connect additional equipment to the printer to query its current status prior to performing service because the printer's status may have changed after the technician was summoned, and/or because display capabilities of the printer may be limited. While waiting for the service technician to arrive and during the period when service is being performed, the printer may be unavailable resulting in a significant loss of productivity.

The ability to quickly obtain printer status would facilitate the servicing of printers, decrease printer downtime, and increase printer availability. Accordingly, there is a need for systems and methods that facilitate obtaining the status of printing devices.

### SUMMARY

Consistent with embodiments disclosed herein, systems and methods for obtaining status information for a printer comprise: receiving a status request, wherein the status request identifies at least one parameter whose status is tracked by the printer; representing the at least one management information base (“MIB”) object using extensible markup language (“XML”), wherein the at least one MIB object corresponds to the at least one parameter identified in the status request; and sending a response to the status request, wherein the response includes an XML representation of the at least one MIB object. In some embodiments, the requested status information may be displayed by parsing the response to the status request. The methods may be performed in whole, or in part, by one or more of a printer, a computer, and/or a handheld device.

Embodiments also relate to software, firmware, and program instructions created, stored, accessed, or modified by processors using computer-readable media or computer-readable memory. The methods described may be performed on a computer and/or a printing device. These and other embodiments are further explained below with respect to the following figures.

### BRIEF DESCRIPTION OF THE DRAWINGS

FIG. 1 shows a block diagram of exemplary system for managing networked printing systems.

FIG. 2 shows a high level block diagram of an exemplary printer.

FIG. 3 shows a flowchart illustrating steps in a method for processing status requests on a requesting device.

FIG. 4 shows a flowchart illustrating steps in a method for responding to a printer status request.

### DETAILED DESCRIPTION

In accordance with embodiments disclosed herein, systems and methods for automatically configuring networked printing devices are presented.

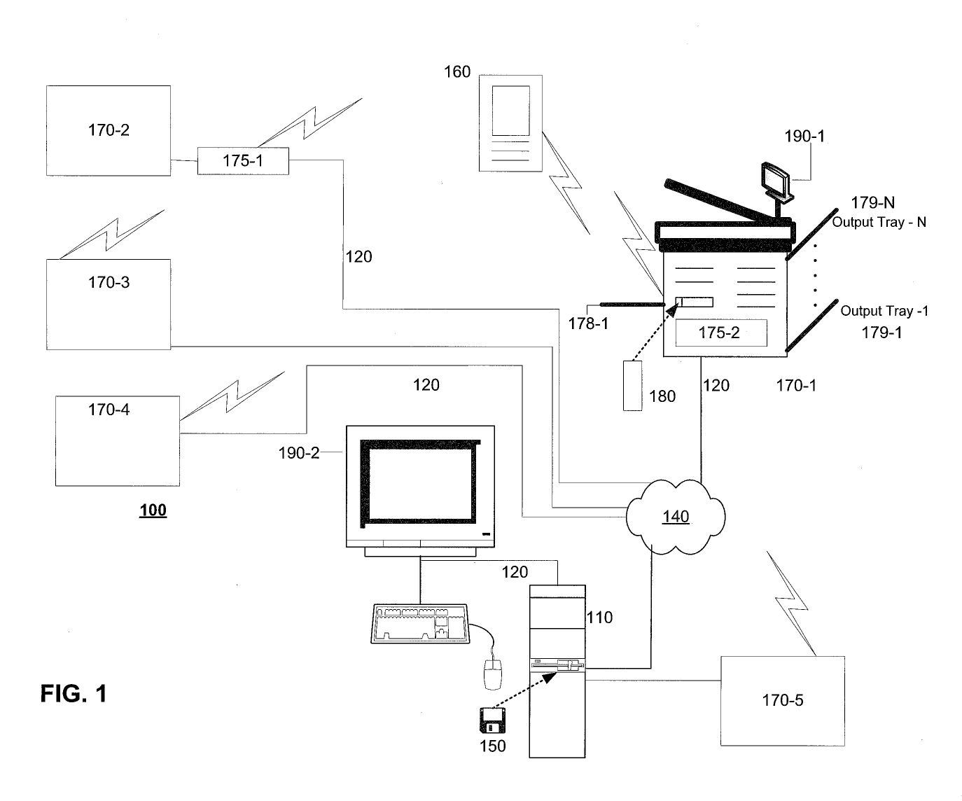

FIG. 1 shows a block diagram of exemplary system 100 for requesting and processing printer status requests. A computer software application for obtaining printer status may be deployed on a network of computers and/or printers, as shown in FIG. 1, that are connected through communication links that allow information to be exchanged using conventional communication protocols and/or data port interfaces.

As shown in FIG. 1, exemplary system 100 includes a computer or computing device 110, printers 170, and a wireless handheld device 160. Network 140 may include subnets, LANs, and/or WANs. Further, network 140 may also include modems, routers, repeaters, and other communication devices (not shown) that permit devices that are coupled to a network 140 to communicate with other devices in accordance with the policies set by a network administrator.

Computing device 110 may be a computer workstation, desktop computer, laptop computer, or any other computing device capable of being used in a networked environment. Computing device 110 may be capable of executing software (not shown) that facilitates obtaining and processing printer status requests for printers 170-1 through 170-5. Computing device 110 may contain a removable media drive 150. Removable media drive 150 may include, for example, 3.5 inch floppy drives, CD-ROM drives, DVD ROM drives, CD±RW or DVD±RW drives, USB flash drives, Memory Sticks™, Secure Digital High Capacity (“SDHC”) cards, and/or any other removable media drives consistent with embodiments of the present invention. Portions of software applications may reside on removable media and be read and executed by computing device 110 using removable media drive 150. In some embodiments, intermediate and final results and/or reports generated by applications may also be stored on removable media.

Printers 170 may be laser printers, ink jet printers, LED printers, plotters, and of various other types. From a functional perspective, printers 170 may take the form of computer printers, facsimile machines, digital copiers, multi-function devices, and/or various other devices that are capable of printing documents. In some embodiments, printers 170 may also support MIBs, which can be RFC based. In some embodiments, the information in the MIB may pertain to the status of various parameters tracked by printer 170. In some embodiments, printers 170 may have Bluetooth™ (IEEE 802.15) wireless interfaces. In some instances, a USB port on a legacy printer that does not support Bluetooth natively may be equipped with a Bluetooth™ dongle (not shown) to make the printer Bluetooth™ capable thereby permitting the printer to communicate wirelessly. The Bluetooth™ protocol permits the exchanging of data over short distances from fixed and mobile devices creating personal area networks (PANs). Thus, Bluetooth™ makes it possible for the print devices to communicate with other Bluetooth™ devices when they are in range. Accordingly, printers 170 that are Bluetooth™ capable may be able to communicate wirelessly with handheld device 160, when the wireless handheld device 160 is located within the communication range of printers 170.

Handheld device 160 may be a cell phone, a smart phone, a handheld computing device such as a Personal Data Assistant (“PDA’), or a hybrid platform that combines a variety of computing functions with communication capabilities thereby providing a mobile computing and communications platform. For example, handheld device 160 may have a CPU, memory, wired and wireless communication interfaces, and may also be capable of running an operating system, executing program code including device driver code and other applications, and displaying black and white and/or color graphic output on a display built-in or coupled to the device. In some embodiments, handheld device 160 may have a USB port (not shown) and may also be capable of communicating wirelessly using one or more wireless protocols such as Bluetooth™.

Connection 120 couples computing device 110, printers 170-1-170-5 to network 140. In some instances, connection 120 may couple computing device 110, printers 170-1-170-5, and handheld device 160 to a wireless Bluetooth™ personal area network. Connection 120 may be implemented as a wired or wireless connection using appropriate conventional communication protocols and/or data port interfaces. In general, connection 120 can be any communication channel that allows transmission of data between the devices. In one embodiment, for example, devices may be provided with data ports, such as Bluetooth™, USB™, SCSI, FIREWIRE™, and/or BNC ports for transmission of data through the appropriate connection 120. The communication links could be wireless links or wired links or any combination that allows communication between computing device 110, handheld device 160, and printers 170.

Printers 170 may be controlled by hardware, firmware, or software, or some combination thereof. Printers 170 may include one or more print controller boards 175, such as exemplary print controllers 175-1 and 175-2, which may control the operation of printers 170, and may also be capable of generating printer status requests to printers 170. In some embodiments, printers 170 may be controlled by firmware or software resident on memory devices in print controllers 175. In some embodiments, print controllers 175 may be capable of communicating wirelessly using a Bluetooth™ protocol. In some embodiments, print controllers 175 may also have an USB port accessible by external devices, such as handheld device 160 or a Bluetooth™ dongle. In general, print controllers 175 may be internal or external to printers 170. Exemplary print controllers 175 may also be controlled in part by software, including print servers, printer drivers, or other software, running on computing device 110, and/or handheld device 160.

Printers, such as exemplary printer 170-1, may also include consoles 190 such as consoles 190-1 and 190-2, or other interfaces to allow configuration options to be set, passwords and/or user identification and authentication information to be entered, and other status messages to be displayed. In some embodiments, configuration options may be set or displayed using a display or user-interface on a monitor for a computer coupled to printers 170. For example, user interfaces to set one or more configuration options on printer 170-1 may be displayed on console 190-1. For example, the print resolution, document sizes, color options, and other configuration parameters may be user-configurable.

Users may also be able to log in to a printer 170 to perform administrative functions such as to enable software or firmware on printer 170 to perform various functions. In some embodiments, the log in process may require a password or other user-authentication mechanism. A user may also be able to specify input trays 178 and/or output trays 179 and the use of automatic document feeders to allow batch processing of documents. Printers 170 may have multiple input trays 178 and/or output trays 179. Output trays 179 can hold printed documents that have been processed by a printer.

A computer software application to obtain and/or process status information for printers 170 may be deployed on any of the exemplary computers 110, handheld device 160, print controllers 175, and/or printers 170, as shown in FIG. 1. For example, computing device 110 could execute software, such as a user interface coupled to a print driver, to allow users to monitor the status of printer 170-1. An independent application may also execute concurrently on printer 170-2 based on its configuration. In another example, an application resident on print controller 175-1 could be configured using computer 110 but execute on printer 170-1. In general, applications may execute in whole or in part on one or more computers 110, handheld devices 160, print controllers 175, and/or printers 170 in the system. The embodiments described herein are exemplary only and other embodiments and implementations will be apparent to one of ordinary skill in the art.

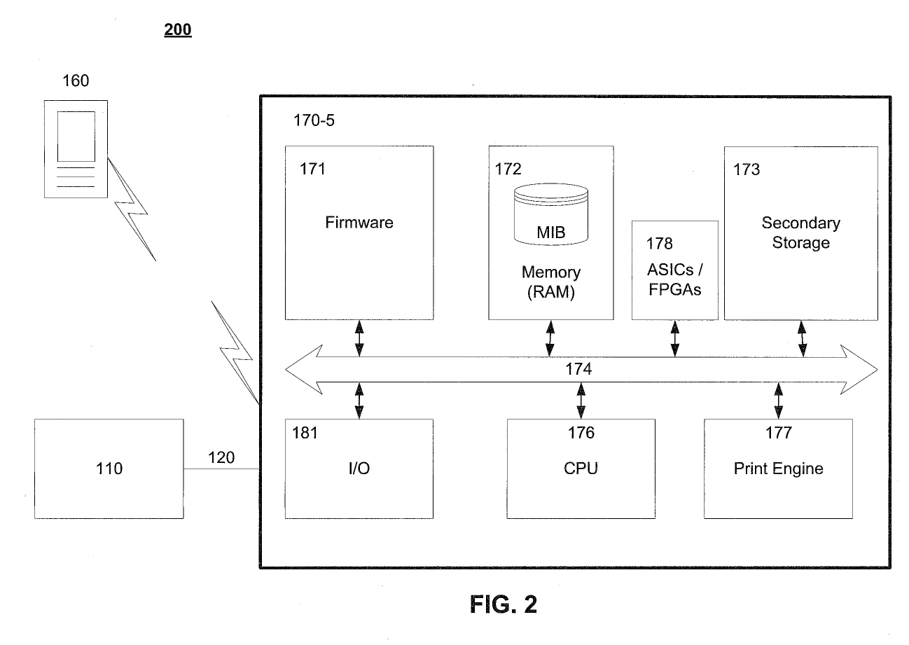

FIG. 2 shows a high-level block diagram of exemplary printer 170-5 coupled to a computing device 110 over connection 120, which, in one instance, may be USB (in the case of computing device 110) or Bluetooth™ (in the case of handheld device 160). Exemplary printer 170-5 may contain bus 174 that couples CPU 176, firmware 171, memory 172, input-output (“I/O”) module 181, print engine 177, and secondary storage device 173. Exemplary printer 170-5 may also contain other Application Specific Integrated Circuits (ASICs), and/or Field Programmable Gate Arrays (FPGAs) 178 that are capable of executing portions of an application to configure printers, and to print or process documents. Exemplary printer 170-5 may also be able to access network 140 using I/O module 181 and connection 120. In some embodiments, printer 170 may also be capable of executing software including, a printer operating system, printer status request processing and printer configuration software, as well as other appropriate application software.

Exemplary I/O module 181 may also provide Bluetooth™ connectivity to printer 170-5, either directly, or through a Bluetooth™ dongle. I/O module 181 may also permit communication with computer 110 over USB connection 120. Information received from handheld device 160 and/or computer 110 may be processed by I/O module 181 and stored in memory 172. I/O module 181 may also notify CPU 176 about the communications. The communications may include data, commands, requests, and/or acknowledgements according to the communications protocol being used. CPU 176 may retrieve any information stored in memory 172 and process the information further.

Exemplary CPU 176 may be a general-purpose processor, a special purpose processor, or an embedded processor. CPU 176 can exchange data including control information and instructions with memory 172 and/or firmware 171. Memory 172 may be any type of Dynamic Random Access Memory (“DRAM”) such as but not limited to SDRAM, or RDRAM. Firmware 171 may hold instructions and data including but not limited to a boot-up sequence, pre-defined routines including routines for processing incoming messages, composing outgoing messages, configuration management, document processing, and other code. In some embodiments, code and data in firmware 171 may be copied to memory 172 prior to being acted upon by CPU 176. Data and instructions in firmware 171 may be upgradeable using one or more of computer 110, network 140, removable media coupled to printer 170, and/or secondary storage 173.

Exemplary CPU 176 may act upon instructions and data and provide control and data to ASICs/FPGAs 178 and print engine 177 to generate printed documents. ASICs/FPGAs 178 may also provide control and data to print engine 177. FPGAs/ASICs 178 may also implement one of configuration management, message processing, and other print related algorithms.

Intermediate and final printable data, messages, printer status, and configuration information pertaining to one or more printers 170 may be stored in memory 172 or secondary storage 173. In some embodiments, status information may be stored in a Management Information Base (“MIB”) in memory 172. In some embodiments, the information in the MIB may relate to the status of various parameters tracked by printer 170. In some embodiments, the values of objects may be obtained initially when the printer is reset or started-up and then updated periodically. In some embodiments, an interrupt may be used to inform CPU 176 that an update is needed or than one or more tracked parameters have changed. The MIB for a printer, or printer-MIB, is specified in various standards documents (such as RFC 1759, and/or RFC 3805).

The MIB structure is typically organized in terms of a System MIB (such as RFC 1213), a Host MIB (such as RFC 2790), and a Printer MIB, in which the following exemplary MIB objects can be used to maintain and obtain printer status.

System MIB
1. SysDescr
2. SysName
3. SysLocation

Host MIB
1. hrPrinterStatus

Printer MIB
1. prtGeneralPrinterName
2. prtCoverStatus
3. prtCoverDescription
4. prtInputStatus
5. prtMarkerSuppliesDescription
6. prtMarkerSuppliesLevel
7. prtAlertDescription

Note that the description above is exemplary and for descriptive purposes only and may represent only a subset of the MIB objects available and/or tracked in a given printer. Various other MIB objects that are specified in the RFC may also be used according to the parameters tracked by a specific printer and/or the degree of printer status detail specified for retrieval. The System MIB lists several objects such as the exemplary SysDescr, SysName, and SysLocation objects listed above that specify the system description, system name and system location, respectively. The Host-MIB provides several status objects that can describe printer status in the context of two tables. For example, the hrPrinterStatus object can take on a range of values, where each value indicates a specific printer status. For example, the values may indicate whether the printer is busy, idle, warming up, or performing various other tasks.

The Printer MIB also includes several objects, such as the exemplary objects prtGeneralPrinterName, prtCoverStatus, prtCoverDescription, prtInputStatus, prtMarkerSuppliesDescription, prtMarkerSuppliesLevel, and prtAlertDescription. For the subset of objects listed above, object prtGeneralPrinterName specifies the printer name; object prtCoverStatus specifies the status of the printers covers and interlocks (i.e. whether any printer doors, trays, etc are open or closed); object prtCoverDescription specifies the manufacturer's name for the provided cover sub-mechanism; object prtInputStatus specifies the current status of the specified input sub-unit; object prtMarkerSuppliesDescription specifies the description of the marker (ink, toner etc) in the specified supply container or receptacle; object prtMarkerSuppliesLevel specifies the current level of the marker (if the specified supply is a container) or the remaining space (if this supply is a receptacle); and object prtAlertDescription, which further elaborates on a specified enumerated alert or provides information in the case where the alert code is classified as ‘other’ or ‘unknown’.

Note also that the specification of standards above is exemplary only and various other established or de-facto standards may also be used. In addition, ongoing updates to the standards, which are published and updated periodically by the Internet Society, the Internet Engineering Task Force, and other standard-setting organizations, may be used to update information contained in the MIB. The methods, systems, and apparatus disclosed herein may be easily adapted to any changes to the MIB structure, and/or to changes in information contained within the MIB as would be apparent to one of ordinary skill in the art.

As shown in FIG. 2, the MIB may be stored in memory 172 and may be updated periodically or in response to specific requests. In some instances, the MIB may reside periodically in secondary storage 173. Exemplary secondary storage 173 may be an internal or external hard disk, or a memory stick, USB drive, SDHC card, flash drive, or any other memory storage device capable of being used by system 200. The MIB may be updated by CPU 176, which may periodically obtain status from various components and sub-assemblies of printer 170-5. For example, CPU 176 may monitor its interrupts, and read memory locations and/or registers on various components, and/or invoke applications to determine current status.

Note that printer 170-5 may be capable of providing the MIB information, when requests are made in accordance with the Simple Network Management Protocol (“SNMP”). However, in existing prior art systems, when communication with printer 170-5 occurs using Bluetooth™, USB, or certain other protocols that are not based on the TCP/IP suite, then the devices communicating with printer 170-5 cannot ordinarily obtain this information from printer 170-5. Embodiments disclosed herein facilitate the availability of MIB information from printers 170 to devices (such as handheld device 160) that may be coupled to the printers 170 using non-TCP/IP suite based protocols.

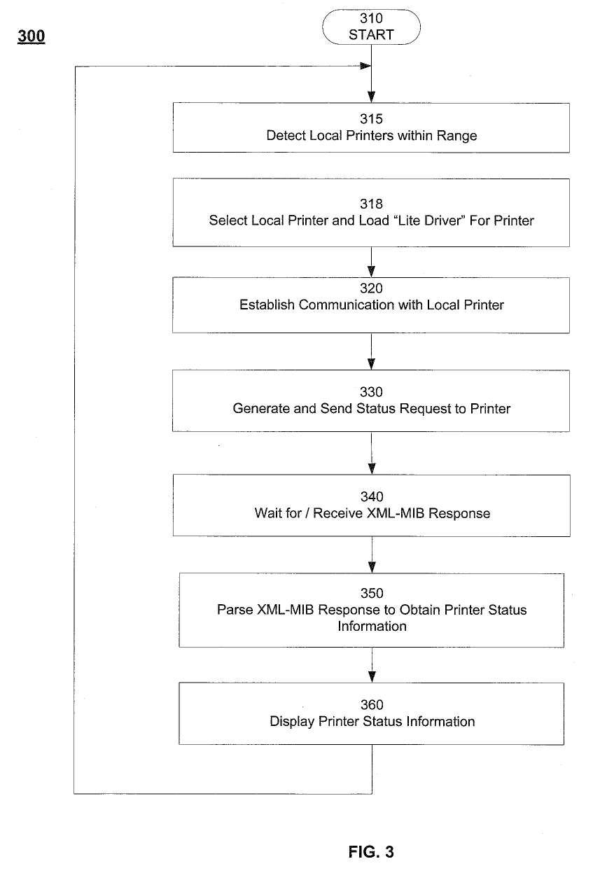

FIG. 3 shows a flowchart illustrating steps in a method for processing status requests on a requesting device. In some embodiments, the method may be performed on handheld device 160, or computing device 110. For the purposes of this discussion, handheld device 160 using a Bluetooth™ protocol is assumed to be the requesting device. In general, the method may be performed by any requesting device that uses other (non-TCP/IP) protocols for communicating with printers 170.

In step 315, handheld device 160 may detect all printers 170 within device range. Because the Bluetooth™ protocol is typically a short range protocol, handheld device 160 may be able to detect physically proximate printers 170. In some embodiments, the user may select one of the detected printers 170 and a driver for the selected printer may be loaded in step 318. For example, handheld device 160 may load a driver for printer 170-5. In some embodiments, to conserve resources on handheld device 160, the driver may be a “lite driver” that provides limited functionality as compared to a regular full-function device driver available for the selected printer. In some embodiments, a Service Discovery Protocol (“SDP”) may be used to discover the services that handheld device 160 and printer 170 support based on their individual Bluetooth™ profiles.

In step 320, handheld device 160 may establish communication with the printer and generate and send a status request to the printer in step 330. The request may be sent using any agreed upon protocol for communication between handheld device and printer 160. In some embodiments, the request may be sent by the printer driver running on handheld device 160.

In some embodiments, handheld device may act as a master Bluetooth™ device, and may be able to communicate with several printers devices in a round robin fashion. Accordingly, handheld device 160 may interact with several printers 170, as master, so that the printers 170 and the handheld device 160 form a Wireless User Group, or piconet. In a piconet, Bluetooth™ technology protocols allow the master device (the handheld) to interconnect with up to seven active devices. In addition, up to 255 other devices can be inactive, which the master device can bring into active status at any time. Accordingly, the master may activate new printers and send out new requests for printer status and receive responses while other printers are processing any previously sent requests. Thus, in some embodiments, printer status requests and responses may be interleaved.

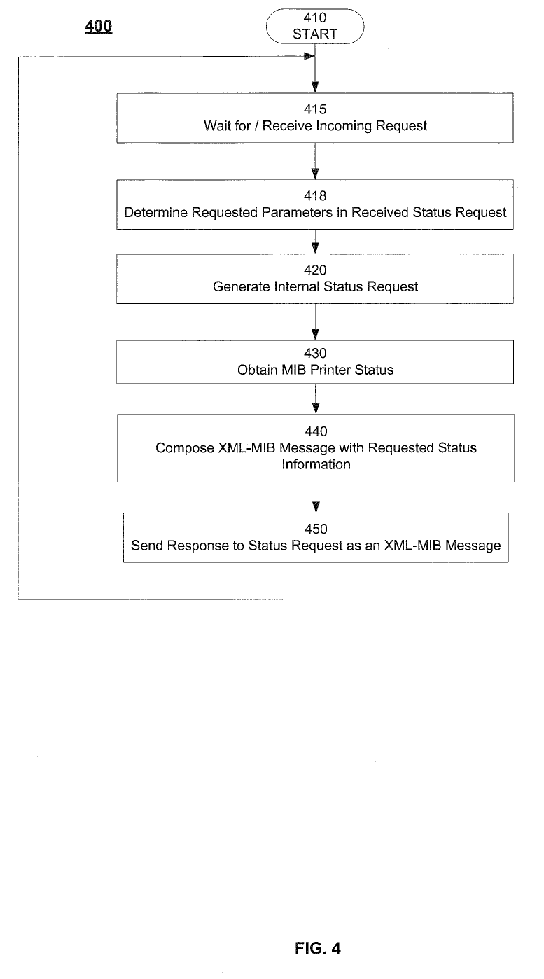

The printer status request sent by handheld device 160 may be processed by printer 170. An exemplary flowchart 400 describing the processing of the printer status request is shown in FIG. 4 and a description of that process appears following the description of FIG. 3. In some embodiments, printer 170 may process the printer status request and obtain current status information from the MIB structure in printer memory 172.

After processing the printer status request, printer 170 may respond with current printer status information in the form of extensible Markup Language (“XML”) MIB data. XML is a general-purpose specification that facilitates the creation of customized markup languages with user-defined mark-up elements. XML can facilitate the sharing structured data. The XML-MIB data may be transmitted to handheld device 160 over the Bluetooth™ connection.

Note that because multiple printer status requests may be outstanding, responses to any outstanding requests may arrive out-of-order. The order of arrival of responses may depend on the order in which status requests complete. However, because each Bluetooth device is uniquely identifiable, the printing device sending the response may easily be identified.

In step 340, handheld device 160 may wait for and receive the response from printer 170. An exemplary instance of a partial XML-MIB structure to hold MIB information is shown below.

```
<?xml version=“1.0” encoding=“UTF-8”?>
<XML-MIB-file>
  <MIB-L Level=“Public”>
    <MIB-G Group=“System MIB group”>
      <SysDescr>KM Printers</SysDescr>
      <SysName>Mike's Printer</SysName>
      <SysLocation>Mike's Office</SysLocation>
    </MIB-G>
    <MIB-G Group =“Host MIB group”>
      <hrPrinterStatus>WarmingUp</hrPrinterStatus>
    </MIB-G>
  </MIB-L>
</XML-MIB-file>
```

As discussed, objects in the System MIB group help identify and locate printer 170. The SysDescr object identifies printer 170 as part of “KM Printers,” and specifies the printer's name using the SysName object, which identifies the printer as “Mike's Printer”, whose location is specified using the SysLocation object as “Mike's Office”. The hrPrinterStatus object in the Host MIB group indicates that the printer is “warming up”.

In step 350, the received XML-MIB data may be parsed to obtain printer status information. For example, a CPU or other processor on handheld device 160 may run an application program to parse the XML-MIB data. The extracted printer status information may be formatted and displayed on the screen of handheld device 160 using an appropriate user interface. After displaying the information, the algorithm returns to step 315 and begins another iteration.

Using disclosed embodiments, a service technician may be able to quickly obtain information on physically proximate printers as the technician moves through the premises where the printers are located. Based on printer status information that is displayed on the technician's mobile device, the technician may be able to quickly identify printers needing service and attend to any outstanding service requests in a timely manner. Printers that do not need service may be skipped. In situations where the printers do not have Bluetooth™ capability, the technician may be able to use a USB or other port on the handheld device to quickly obtain printer status information without resorting to external equipment.

FIG. 4 shows a flowchart 400 illustrating steps in a method for responding to a printer status request. In some embodiments, portions of the method may be performed by CPU 176 on printer 170. In step 415, printer 170 may wait for an incoming printer status request. In some embodiments, printer 170 may identify itself as a Bluetooth™ device and present its profile for SDP purposes. In some embodiments, the printer may begin accepting printer status requests after it has established communication with handheld device 160. In some embodiments, I/O module 281 may provide the functionality to send and receive messages over the Bluetooth™ connection.

In step 418, the printer may parse the incoming request to determine the requested status parameters that have been identified in the request. In step 420, the status parameters determined by the request parser may be used to generate an internal status request. For example, CPU 176 may invoke one or more routines to obtain the values of the requested status parameters and update the MIB accordingly.

In some embodiments, the MIB status parameters requested by handheld device 160 may be converted to XML in step 430. For example, CPU 176 may invoke routines to convert the MIB data to XML-MIB data. In step 440, a message may be composed with requested status parameters using the XML-MIB data. In step 450, the message may be transmitted to handheld device 160. The algorithm then returns to step 415, and begins another iteration.

In some embodiments, a program for conducting the process described in algorithms 300 and 400 can be recorded on computer-readable media 150 or computer-readable memory. These include, but are not limited to, Read Only Memory (ROM), Programmable Read Only Memory (PROM), Flash Memory, Non-Volatile Random Access Memory (NVRAM), or digital memory cards such as secure digital (SD) memory cards, Compact Flash™, Smart Media™, Memory Stick™, and the like. In some embodiments, one or more types of computer-readable media may be coupled to printer 170. In certain embodiments, portions of a program to implement the systems, methods, and structures disclosed may be delivered over network 140.

Other embodiments of the present invention will be apparent to those skilled in the art from consideration of the specification and practice of one or more embodiments of the invention disclosed herein. It is intended that the specification and examples be considered as exemplary only, with a true scope and spirit of the invention being indicated by the following claims.

What is claimed is:

1. A computer implemented method for obtaining status information for a printer comprising the computer-implemented steps of:
receiving a status request, wherein the status request identifies at least one parameter whose status is tracked by the printer;
representing at least one management information base (“MIB”) object in the printer using extensible markup language (“XML”), wherein the at least one MIB object corresponds to the at least one parameter identified in the status request; and
sending a response to the status request, wherein the response includes the XML representation of the at least one MIB object.

2. The method of claim 1, further comprising displaying the requested status information, wherein the displayed status information is obtained by parsing the received response to the status request.

3. The method of claim 1, wherein the receiving of the status request and the sending of the response to the status request occur over one of:
a Bluetooth connection; or
a USB connection.

4. The method of claim 1, wherein representing at least one management information base (“MIB”) object in the printer using extensible markup language (“XML”) further comprises:
updating the at least one management information base (“MIB”) object in the printer; and
using the updated value of the at least one MIB object in the XML representation of the at least one MIB object.

5. The method of claim 4, wherein updating the at least one management information base (“MIB”) object further comprises:
obtaining a current value of the status of the at least one parameter; and
storing the obtained value of the status of the at least one parameter in the MIB object.

6. The method of claim 1, wherein the method is performed on a printer.

7. The method of claim 2, wherein the displaying of the requested status information is performed on a handheld device that receives the response to the status request.

8. A computer implemented method for obtaining printer status information comprising the computer-implemented steps of:
sending a status request to a printer, wherein the status request identifies at least one parameter whose status is tracked by the printer;
receiving a response to the status request, wherein the response includes an XML representation of the at least one MIB object; and
displaying the requested status information, wherein the displayed status information is obtained by parsing the response to the status request.

9. The method of claim 8, wherein the method is performed on a handheld device.

10. The method of claim 8, wherein the sending of the status request and the receiving of the response to the status request occur over one of:
a Bluetooth connection; or
a USB connection.

11. A system comprising at least one computing device coupled to a plurality of printers, wherein the computing device and the plurality of printers perform steps in a method for obtaining status information for at least one printer in the plurality of printers, the computer-implemented steps comprising:
sending a status request to the at least one printer, wherein the status request identifies at least one parameter whose status is tracked by the printer;
representing at least one management information base (“MIB”) object in the printer using extensible markup language (“XML”), wherein the at least one MIB object corresponds to the at least one parameter identified in the status request; and
sending a response to the status request, wherein the response includes the XML representation of the at least one MIB object.

12. The system of claim 11, further comprising displaying the requested status information for the at least one printer, wherein the displayed status information is obtained by parsing the received response to the status request.

13. The system of claim 11, wherein the sending of the status request and the response to the status request occur over one of:
a Bluetooth connection; or
a USB connection.

14. The system of claim 11, wherein representing at least one management information base (“MIB”) object in the printer using extensible markup language (“XML”) further comprises:
updating the at least one management information base (“MIB”) object in the printer; and
using the updated value of the at least one MIB object in the XML representation of the at least one MIB object.

15. The system of claim 14, wherein updating the at least one management information base (“MIB”) object in the at least one printer further comprises:
obtaining a current value of the status of the at least one parameter; and
storing the obtained value of the status of the at least one parameter in the MIB object.

16. A computer-readable medium that stores instructions, which when executed by a processor, perform steps in a method for obtaining status information for a printer the computer-implemented steps comprising:
receiving a status request, wherein the status request identifies at least one parameter whose status is tracked by the printer;
representing at least one management information base (“MIB”) object using extensible markup language (“XML”), wherein the at least one MIB object corresponds to the at least one parameter identified in the status request; and
sending a response to the status request, wherein the response includes the XML representation of the at least one MIB object.

17. The computer-readable medium of claim 16, further comprising displaying the requested status information, wherein the displayed status information is obtained by parsing the received response to the status request.

18. The computer-readable medium of claim 16, wherein the receiving of the status request and the sending of the response to the status request occur over one of:
a Bluetooth connection; or
a USB connection.

19. The computer-readable medium of claim 16, wherein representing at least one management information base (“MIB”) object in the printer using extensible markup language (“XML”) further comprises:
updating the at least one management information base (“MIB”) object in the printer; and
using the updated value of the at least one MIB object in the XML representation of the at least one MIB object.

20. The computer-readable medium of claim 19, wherein updating the at least one management information base (“MIB”) object further comprises:
obtaining a current value of the status of the at least one parameter; and
storing the obtained value of the status of the at least one parameter in the MIB object.

21. A computer-readable medium that stores instructions, which when executed by a processor, perform steps in a method for obtaining status information for a printer the computer-implemented steps comprising:
sending a status request to a printer, wherein the status request identifies at least one parameter whose status is tracked by the printer;
receiving a response to the status request, wherein the response includes an XML representation of the at least one MIB object; and
displaying the requested status information, wherein the displayed status information is obtained by parsing the response to the status request.

22. The computer-readable medium of claim 21, wherein the method is performed on a handheld device.

23. The computer-readable medium of claim 21, wherein the sending of the status request and the receiving of the response to the status request occur over one of:
a Bluetooth connection; or
a USB connection.
